(19) United States
(12) Patent Application Publication
(10) Pub. No.: US 2021/0365219 A1
(43) Pub. Date: Nov. 25, 2021

(54) PRINT JOB MANAGEMENT APPARATUS, IMAGE FORMING SYSTEM, AND REPRESENTATION CONTROL METHOD

(71) Applicant: KONICA MINOLTA, INC., Tokyo (JP)

(72) Inventor: Hiroki HIDAKA, Tokyo (JP)

(73) Assignee: KONICA MINOLTA, INC., Tokyo (JP)

(21) Appl. No.: 17/233,674

(22) Filed: Apr. 19, 2021

(30) Foreign Application Priority Data
May 21, 2020 (JP) 2020-088992

(51) Int. Cl. G06F 3/12

(52) U.S. Cl. CPC G06F 3/1208; G06F 3/1274; G06F 3/1256

(57) ABSTRACT

A management apparatus obtains a print job. When setting for performing printing as being divided into test printing and main printing has been made for the print job, the management apparatus shows on a display, an image showing a condition of execution of a test print job and an image showing a condition of execution of the main print job.

The entire disclosure of Japanese Patent Application No. 2020-088992 filed on May 21, 2020 is incorporated herein by reference in its entirety.

### BACKGROUND

### Technological Field

The present disclosure relates to a print job management apparatus, an image forming system including a print job management apparatus, and a representation control method in a print job management apparatus.

### DESCRIPTION OF THE RELATED ART

An image forming apparatus such as a printer or a multi-functional printer (MFP) has conventionally been known. The image forming apparatus receives a print command from an external information processing apparatus and performs printing based on a print job included in the print command.

For example, Japanese Laid-Open Patent Publication No. 2009-223671 discloses such a printing system. In the printing system, when a result of printing as expected by a user is not obtained in printing by a desired primer in the printing system, reprinting from another printer can be performed without transmission by the user of an instruction for printing again from a personal computer (PC).

A production printer (which is also referred to as an “on-demand printer”) used in such fields as commercial printing and central reproduction department has been known as an exemplary printer. The production printer provides output of a plurality of copies (volumes) of printed products, in such a case, test printing (finish-check printing) may be performed. Main printing (full-scale or full-fledged printing) is performed after test printing.

For example, Japanese Laid-Open Patent Publication No. 2012-165331 discloses an image forming apparatus that reads a result f image formation and output and checks the result.

### SUMMARY

At a site where a large-scale machine such as a production printer is used for printing, normally, an operator (which is also referred to as a “job manager” below) who transmits a print job to an image forming apparatus by operating a PC is different from an operator (which is also referred to as a “machine manager” below) who operates the image forming apparatus. In such a case, the machine manager notifies the job manager of a result of test printing. The job manager checks the given result of checking on a PC. When the result of checking is, for example, satisfactory, the job manager transmits a main print job to the image forming apparatus.

In performing printing as being divided into test printing and main printing as such, if the job manager could check a condition of execution of each type of printing, works could be more efficient. In particular, in an image forming system including a plurality of production printers, the job manager allocates each of a large number of jobs to any of the plurality of production printers. Therefore, if the job manager could check the condition of execution of a test print job and a condition of execution of a main print job, efficiency in works will be improved.

The present disclosure provides a print job management apparatus that allows a job manager to check a condition of execution of a test print job and a condition of execution of a main print job, an image forming system including the print job management apparatus, and a representation control method in the print Job management apparatus.

To achieve at least one of the abovementioned objects, according to an aspect of the present invention, a print job management apparatus reflecting one aspect of the present invention comprises obtaining means for obtaining a first print job and representation control means for controlling a display to show a first image and a second image when setting for performing printing as being divided into test printing and main printing has been made for the first print job, the first image showing a condition of execution of a test print job, the second image showing a condition of execution of a main print job.

To achieve at least one of the abovementioned objects, according to another aspect of the present invention, an image forming system reflecting another aspect of the present invention comprises a print job management apparatus and an image forming apparatus. The print job management apparatus obtains a print job from the outside. The print job management apparatus has the image forming apparatus execute the obtained print job. When setting for performing printing as being divided into test printing and main printing has been made for the print job, the print job management apparatus shows a first image showing a condition of execution of a test print job and a second image showing a condition of execution of a main print job.

To achieve at least one of the abovementioned objects, according to yet another aspect of the present invention, a representation control method reflecting yet another aspect of the present invention comprises obtaining a print job and showing, when setting for performing printing as being divided into test printing and main printing has been made for the print job, a first image showing a condition of execution of a test print job and a second image showing a condition of execution of a main print job,

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention,

FIG. 1 is a diagram showing a schematic configuration of an image forming system.

FIG. 2 is a block diagram for illustrating a functional configuration of a management apparatus.

FIG. 3 is a diagram showing a hardware configuration of the management apparatus.

FIG. 4 is a diagram showing a screen shown on a display.

FIG. 5 is a diagram for illustrating a method of setting an automatic inspection process.

FIG. 6 is a diagram for illustrating allocation of a print job #1 to an image forming apparatus.

FIG. 7 is a diagram showing a screen when print job #1 is allocated to an image forming apparatus #1 by an operation shown in FIG. 6.

FIG. 8 is a diagram collectively illustrating a series of flows until allocation of a print job #2 to an image forming apparatus #2.

FIG. 9 is a diagram for illustrating transmission and reception of data between the manage lent apparatus and image forming apparatus #1.

FIG. 10 is a diagram for illustrating processing performed after reception by the management apparatus of a notification #1 from the image forming apparatus.

FIG. 11 is a diagram for illustrating transmission and reception of data between the management apparatus and image forming apparatus #1.

FIG. 12 is a diagram for illustrating processing performed alter reception by the management apparatus of a notification #2 from the image forming apparatus.

FIG. 13 is a diagram for illustrating transmission and reception of data between the management apparatus and image forming apparatus #1.

FIG. 14 is a diagram for illustrating processing performed after reception by the management apparatus of a notification #3 from the image forming apparatus.

FIG. 15 is a diagram for illustrating processing performed when a print job #3 for which setting of the automatic inspection process has not been made is allocated to the image forming apparatus.

FIG. 16 is a flowchart for illustrating an exemplary flow of processing performed in the management apparatus.

FIG. 17 is a diagram for illustrating an exemplary flow of processing performed in the management apparatus after transmission of a test print job to the image forming apparatus.

FIG. 18 is a diagram showing a screen shown on the display.

FIGS. 19 and 20 are each a diagram for illustrating processing performed when a print job is allocated to the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

An image forming system in an embodiment will be described. below with reference to the drawings. When the number and an amount are mentioned in an embodiment described below, the scope of the present disclosure is not necessarily limited to the number and the amount unless otherwise specified. The same or corresponding elements have the same reference numerals allotted and redundant description may not be repeated.

The drawings are not to scale, and for facilitating understanding of a structure, the drawings may be modified in scale for clarification of the structure, Each modification described below may selectively be combined as appropriate.

<A. image Forming System>

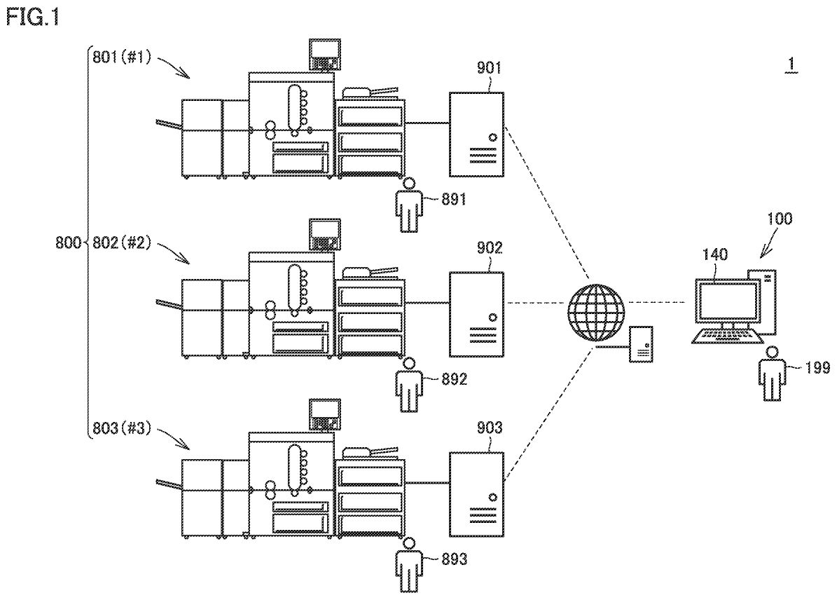

FIG. 1 is a diagram showing a schematic configuration of an image forming system 1.

Referring to FIG. 1, image forming system 1 includes a management apparatus 100, a plurality of image forming apparatuses 801, 802, and 803, and digital front end (WE) processors 901, 902, and 903.

In the present example, production printers are provided as the plurality of image forming apparatuses 801, 802, and 803. For the sake of convenience of description, image forming apparatuses 801, 802, and 803 are also referred to as image farming; apparatuses #1, #2, and #3 below, respectively. When image forming apparatuses 801, 802, and 803 are not distinguished from one another, they are simply referred to as an “image forming apparatus 800.”

DFE processor 901 is communicatively connected to image forming apparatus 801. DFE processor 901 is communicatively connected to management apparatus 100 over a network. Similarly, DFE processor 902 is communicatively connected to image forming apparatus 802 and management apparatus 100. DFE processor 903 is communicatively connected to image forming apparatus 803 and management apparatus 100.

Management apparatus 100 is thus communicatively connected to each image forming apparatus 800.

Management apparatus 100 is an apparatus that manages a print job. Management apparatus 100 is typically a personal computer (PC). Management apparatus 100 includes a display (display unit) 140. Management apparatus 100 is operated by a job manager 199.

A job management application for managing a print job is installed in management apparatus 100. The job management application performs a function to allocate to a document provided from the outside to management apparatus 100, image forming apparatus 800 that executes a print job based on the document.

Specifically, job manager 199 determines (designates) image forming apparatus 800 to execute a print job front among a plurality of image forming apparatuses 800 by using a user interface (specifically, a display screen) provided by the job management application. Specifically, job manager 199 checks a condition of execution by each image forming apparatus 800 and determines image forming apparatus 800 to which a prim job is to be provided. Job manager 199 thus allocates a print job to image forming apparatus 800.

DFE processors 901, 902, and 903 convert a document into a data format in which image forming apparatus 800 can process the document, based on an instruction from the job management application. The converted data is transmitted to image forming apparatus 800.

Image forming apparatus 800 receives the converted data front a corresponding DFE processor (901, 902, or 903). Image forming apparatus 800 generates an image based on the data Image forming apparatus 800 transfers the generated image to paper, Image forming apparatus 800 ejects paper to a tray.

Image forming apparatus 801 is operated by a machine manager 891. Similarly, image forming apparatuses 802 and 803 are operated by machine managers 892 and 893, respectively.

Machine managers 891 to 893 inspect (manage) a stain or a color shade of a printed product. Machine managers 891 to 893 notify job manager 199 of a result of checking of the printed product. Typically, machine managers 891 to 893 notify management apparatus 100 of the result of checking of the printed product typically by providing prescribed inputs to image forming apparatuses 801, 802, and 803.

<B. Management Apparatus>

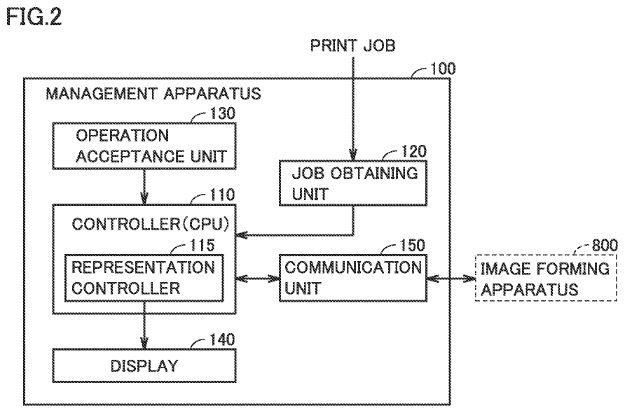

FIG. 2 is a block diagram for illustrating a functional configuration of management apparatus 100.

Referring to FIG. 2, management apparatus 100 includes a controller 110, a job obtaining unit 120, an operation acceptance unit 130, a display 140, and a communication unit 150. Controller 110 includes a representation controller 115.

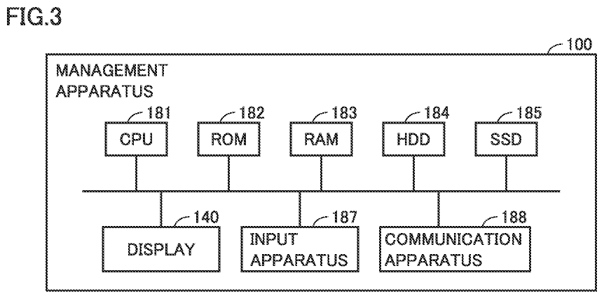

Controller 110 controls overall operations by management apparatus 100. Controller 110 is implemented by execution by a CPU 181 (see FIG. 3) of an operating system (OS) and various applications such as a job management application.

Job obtaining unit 120 obtains a print job from the outside. Job obtaining unit 120 obtains a print job typically through communication. Job obtaining unit 120 receives, for example, a document provided from the outside. Typically, the print job is a job received as an order (accepted job). Job obtaining unit 120 sends the obtained print job to controller 110.

Operation acceptance unit 130 accepts an operation input from job manager 199. Operation acceptance unit 130 sends an accepted input to controller 110. Operation acceptance unit 130 corresponds to an input device such as a keyboard or a mouse.

Communication unit 150 is a communication interface for communication with image forming apparatus 800. Communication unit 150 communicates with image forming apparatus 800 through each of DFE processors 901 to 903. In one aspect, communication unit 150 communicates with a terminal (not shown) used by each of machine managers 891 to 893.

Representation controller 115 controls representation on display 140. Representation controller 115 has display 140 show various screens.

Though details will be described later, job manager 199 uses management apparatus 100 to allocate a print job obtained by management apparatus 100 to one of the plurality of image forming apparatuses 800. When setting for performing printing as being divided into test printing (finish-check printing) and main printing (full-scale or full-fledged printing) has been made for a print job, representation controller 115 has display 140 show an image showing a condition of execution of a test print job and an image showing a condition of execution of a main print job.

FIG. 3 is a diagram showing a hardware configuration of management apparatus 100.

Referring to FIG. 3, management apparatus 100 includes CPU 181, a read only memory (ROIVI) 182, a random access memory (RAM) 183, a hard disk drive (HDD) 184, a solid state drive (SSD) 185, display 140, an input apparatus 187, and a communication apparatus 188. Communication apparatus 188 corresponds to communication unit 150.

Since hardware included in management apparatus 100 has conventionally been known, description will not be repeated.

<C. Specific Example of Operation and Processing>

An operation of management apparatus 100 by job manager 199 and processing performed in management apparatus 100 based on an operation by job manager 199 will now be described with reference to specific examples. Processing performed in management apparatus 100 based on notifications from machine managers 891 to 893 is further described with reference to specific examples. An operation by job manager 199 is accepted at operation acceptance unit 130.

(c1. Representation of Accepted Print Job)

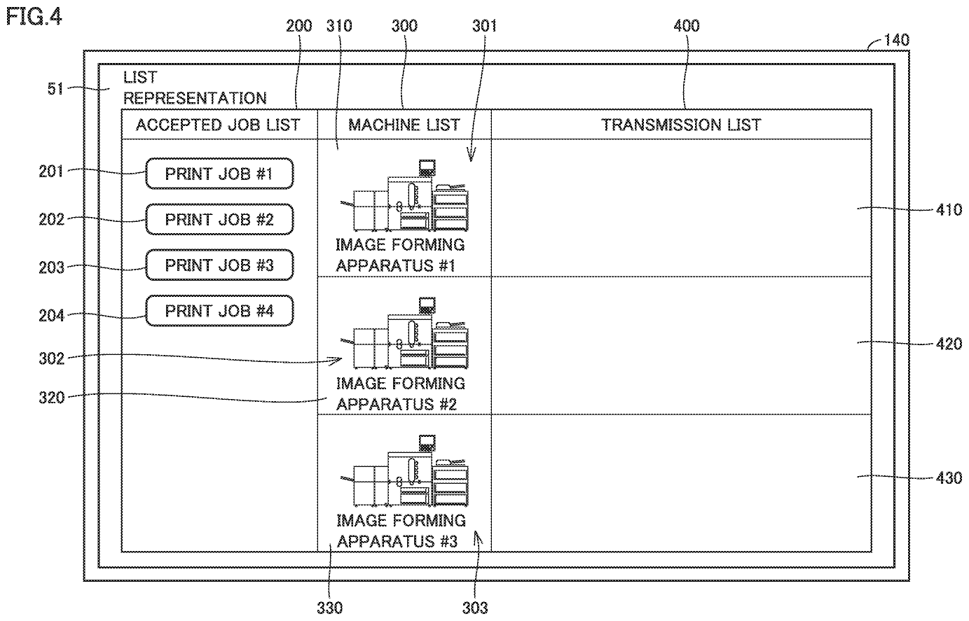

FIG. 4 is a diagram showing a screen shown on display 140.

Referring to FIG. 4, management apparatus 100 (specifically, representation controller 115) shows a plurality of lists on display 140. Management apparatus 100 shows an accepted job list 200, a machine list 300, and a transmission list 400 as being aligned.

When job obtaining unit 120 obtains a print job, management apparatus 100 shows an image showing the obtained job, within accepted job list 200. In the present example, four images 201 to 204 showing four print jobs #1 to #4 are shown in accepted job list 200.

Machine list 300 includes a plurality of areas 310. 320, and 330. In area 310, an image 301 showing image forming apparatus #1 (801) included in image forming system i is shown. Similarly, in areas 320 and 330, images 302 and 303 showing corresponding image forming apparatuses #2 and #3 (802 and 803) are shown, respectively.

Transmission list 400 includes a plurality of areas 410, 420, and 430. Areas 410, 420, and 430 are arranged in correspondence with areas 310, 320, and 330 in machine list 300. respectively.

In area 410 in transmission list 400, a print job to be processed in image forming apparatus #1 is shown. Similarly, in areas 420 and 430, print jobs to be processed in corresponding image forming apparatuses #2 and #3 are shown, respectively. Details of transmission list 400 will be described later.

(c2. Setting of Automatic Inspection Process)

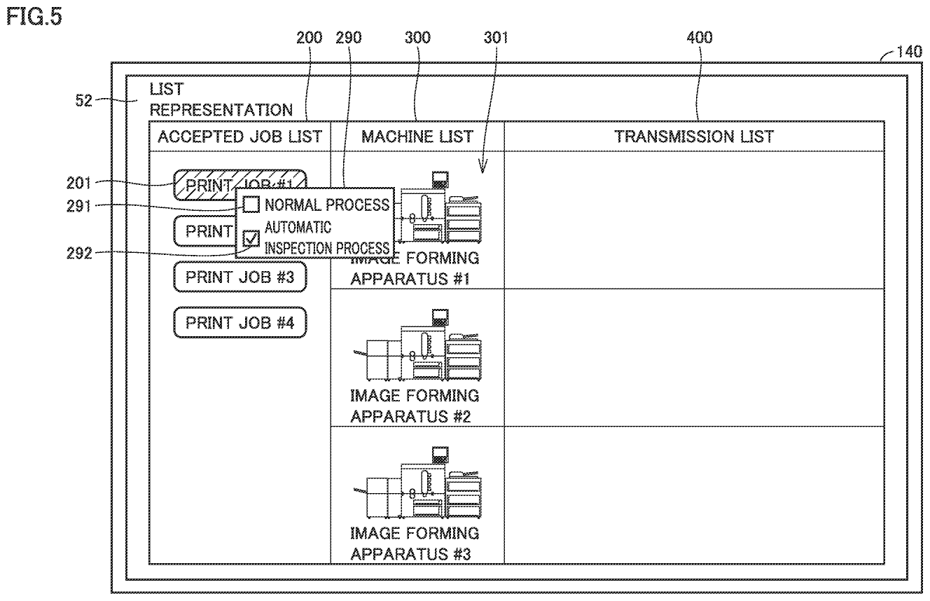

FIG. 5 is a diagram for illustrating a method of setting an automatic inspection process. FIG. 5 is a diagram for illustrating an operation onto the screen shown in FIG. 4.

The “automatic inspection process” refers to a process for inspecting, based on a reference image (criterion image) registered in advance, an output image subsequently provided based on image data identical to the reference image, by using a machine (image forming apparatus). in the present example, a process for performing test printing and registering an image a result of printing of which presents no problem as a reference image is performed. It is an image produced in main printing that is to be inspected. When the automatic inspection process is thus set, processing for dividing a print job into a test print job and a main print job is performed.

Referring to FIG. 5, when job manager 199 clicks, for example, a right button of a mouse (not shown) while an image 201 showing print job #1 is active, an image 290 including two checkboxes 291 and 292 is shown on the screen.

When job manager 199 performs an operation to mark checkbox 291, setting for image forming apparatus 800 to execute a print job in a normal process mode is made. When job manager 199 performs an operation to mark checkbox 292, setting for image forming apparatus 800 to execute a print job in an automatic inspection process mode is made.

In the “normal process,” the automatic inspection process described above is not performed. Therefore, in the normal process. the “process for executing a print job as being divided into a test print job and a main print job” is not performed.

Job manager 199 can bring any of the normal process and the automatic inspection process in correspondence with all print jobs #1 to #4 within accepted job list 200. In a default state, any of checkboxes 291 and 292 may be marked in advance.

Description will be given below assuming that setting of the automatic inspection process has been made for print job #1 as shown in FIG. 5.

(c3. Allocation of Print Job to Image Forming Apparatus)

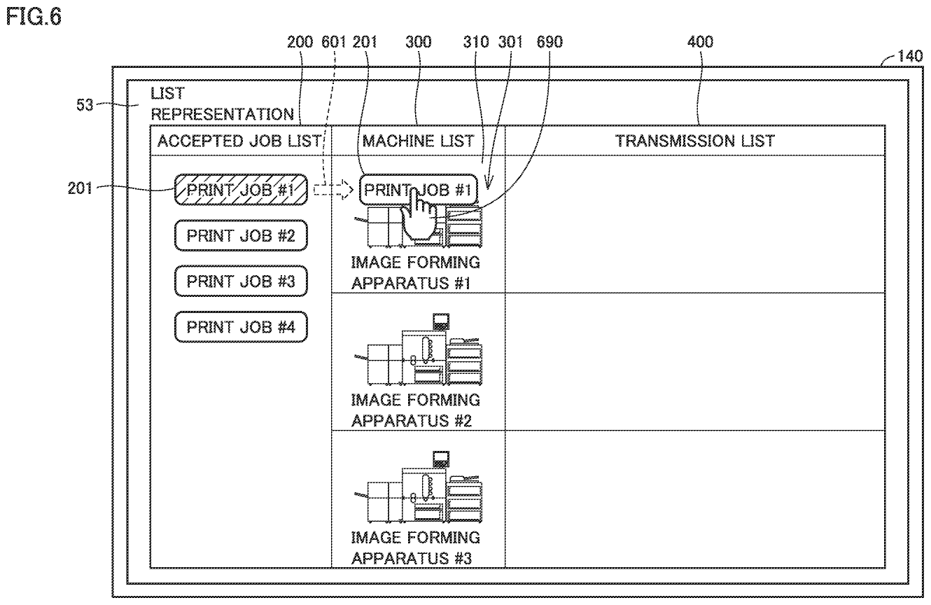

FIG. 6 is a diagram for illustrating allocation of print job #1 to image forming apparatus 800. FIG. 6 is a diagram illustrating an operation after setting of the automatic inspection process for print job #1.

Referring to FIG. 6, job manager 199 performs an operation to move image 201 showing print job #1 in accepted job list 200 to area 310 in machine list 300. For example, job manager 199 moves image 201 in a direction shown with an arrow 601 while the job manager selects image 201 by clicking a left button of the mouse. Specifically, job manager 199 performs an operation to move image 201 into area 310 by moving a cursor 690 of the mouse. Thereafter, job manager 199 releases the left button of the mouse.

Through such a series of operations, print job #1 is allocated to image forming apparatus 41 (801).

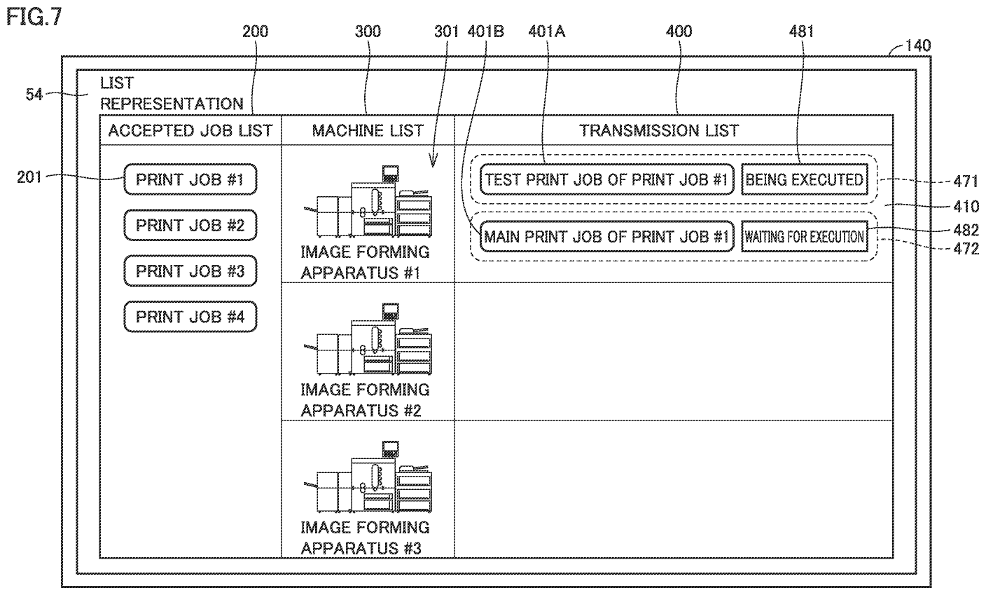

FIG. 7 is a diagram showing a screen when print job #1 is allocated to image forming apparatus #1 by the operation shown in FIG. 6.

Referring to FIG. 7, on display 140, management apparatus 100 (specifically, representation controller 115) shows in area 410 in transmission list 400, an image 471 showing a condition of execution of a test print job of print job #1 and an image 472 showing a condition of execution of a main print job.

Specifically, image 471 includes an image 401A showing the test print job and an image 481 showing the condition of execution. Image 472 includes an image 401B showing the main print job and an image 482 showing the condition of execution. An indication (a character string) of the condition of execution included in image 481 and image 482 is varied successively in accordance with the condition of execution.

In the present example, in the state shown in FIG. 6, there is no image showing the print job in area 410 in transmission list 400. Therefore, management apparatus 100 transmits the test print job of print job #1 to image forming apparatus #1 based on an operation to move image 201 described with reference to FIG. 6.

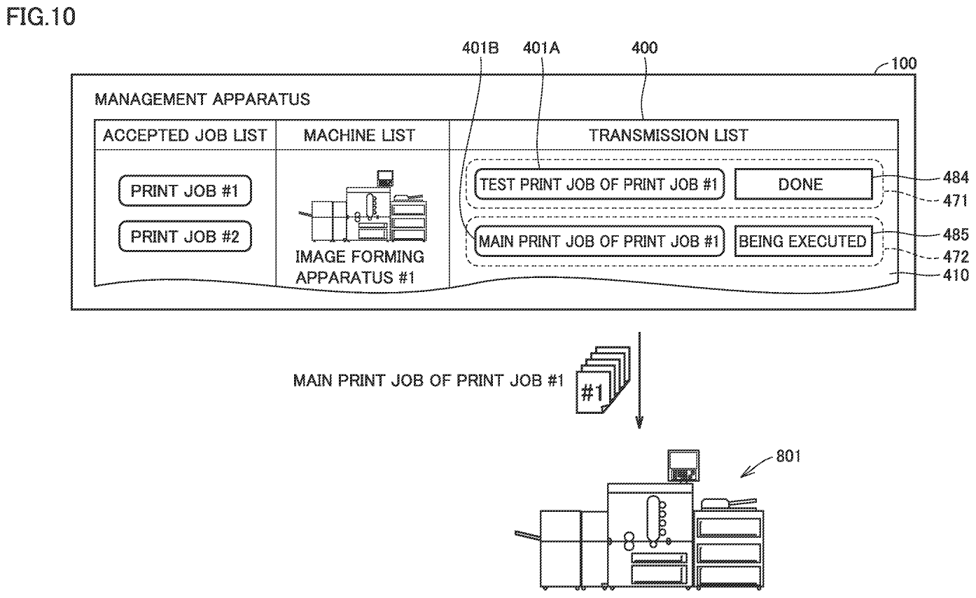

Therefore, representation controller 115 has the condition of execution represented as “being executed” as shown in image 481. At this stage, management apparatus 100 has not yet transmitted the main print job to image forming apparatus #1. Therefore, representation controller 115 has the condition of execution of the main print job represented as “waiting for execution” as shown in image 482. When execution of the job is completed (ends), an indication “done” is given (see FIG. 10).

Management apparatus 100 shows image 471 above image 472 in area 410. In area 410, an image showing the condition of execution of the job is shown sequentially from the top, in accordance with the order of processing in image forming apparatus #1. Management apparatus 100 thus shows on display 140, image 471 as preceding image 472.

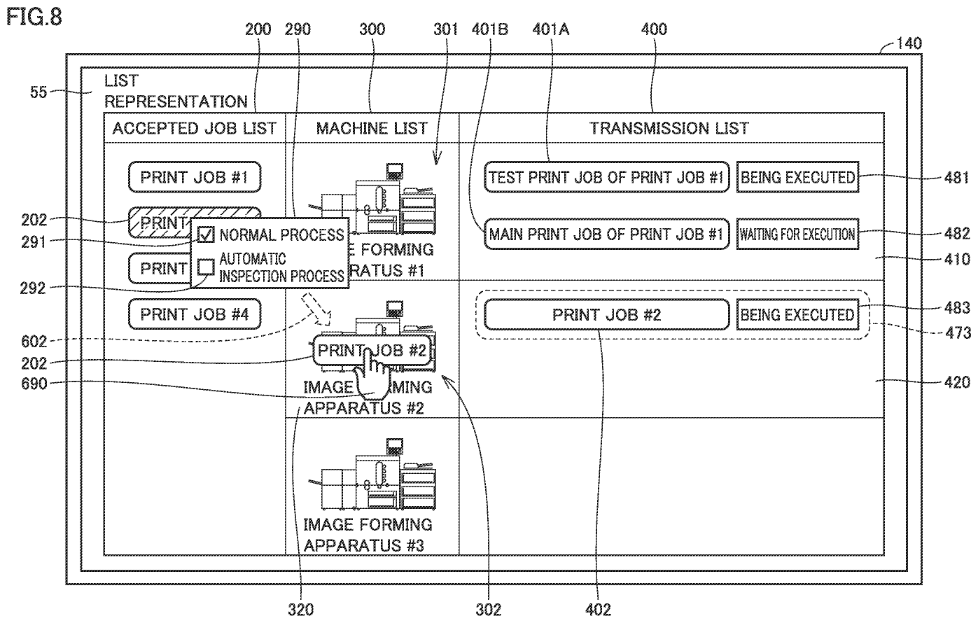

FIG. 8 is a diagram collectively illustrating a series of flows until allocation of print job #2 to image forming apparatus #2.

As job manager 199 marks checkbox 291, the normal process is set for print job #2. In this state, job manager 199 moves image 202 showing print job #2 to area 320 in machine list 300. An image 473 showing the condition of execution of print job #2 is thus shown in area 420 in transmission list 400. Image 473 includes an image 402 showing print job #2 and an image 483 showing the condition of execution.

(c4. Summary)

(1) As described above, management apparatus 100 includes job obtaining unit 120 and representation controller 115. With attention being paid to FIG. 7, job obtaining unit 120 obtains print job #1. When setting for performing printing as being divided into test printing and main printing has been made for print job #1, representation controller 115 has display 140 show image 471 showing a condition of execution of a test print job and image 472 showing a condition of execution of a main print job.

According to such a configuration, job manager 199 can readily know (check) the condition of execution of the test print job and the condition of execution of the main print job. Therefore, job manager 199 can readily know an operation to be performed next. Therefore, according to the configuration, efficiency in operation of image forming apparatus 800 can be enhanced.

(2) With attention being similarly paid to FIG. 7, based on designation of image forming apparatus #1 to execute print job #1, representation controller 115 has display 140 show image 471 and image 472 in association with image 301 showing designated image forming apparatus #1.

According to such a configuration, job manager 199 can readily determine in which image forming apparatus 800 print job #1 is to be executed.

(3) As shown in FIG. 6, operation acceptance unit 130 accepts an operation to designate image forming apparatus #1 to execute print job #1 among a plurality of image forming apparatuses #1 to #3 (801 to 803). Representation controller 115 has the display show image 471 and image 472 in association with image 301 showing designated image forming apparatus #1, based on acceptance of the operation by operation acceptance unit 130.

According to such a configuration, job manager 199 can designate an image forming apparatus to execute print job #1 and can check later which image forming apparatus has been designated.

(4) As shown in FIG. 4, when print job #1 is obtained, representation controller 115 has display 140 show image 201 showing print job #1 as a single job. Representation controller 115 has display 140 show image 471 and image 472 based on designation of image forming apparatus 41 to execute print job #1 after image 201 is shown.

According to such a configuration, simply by checking presence of images 471 and 472, job manager 199 can confirm later that the image forming apparatus to execute print job #1 has already been designated.

(5) The condition of execution of the test print job and the condition of execution of the main print job are any of “waiting for execution,” “being executed,” and “done”.

According to such a configuration, job manager 199 can know which of “waiting for execution,” “being executed,” and “done” the condition of execution of the test print job and the condition of execution of the main print job fail under. Therefore, job manager 199 can readily know an operation to be performed next. Therefore according to the configuration, efficiency in operation of image forming apparatus 800 can be enhanced.

(6) As shown in FIG. 7, representation controller 115 has display 140 show image 471 as preceding image 472. Thus, job manager 199 can visually determine that the print job shown in image 471 is to be processed preferentially over the print job shown in image 472.

(c5. Case Where Result of Test Printing Presents No Problem)

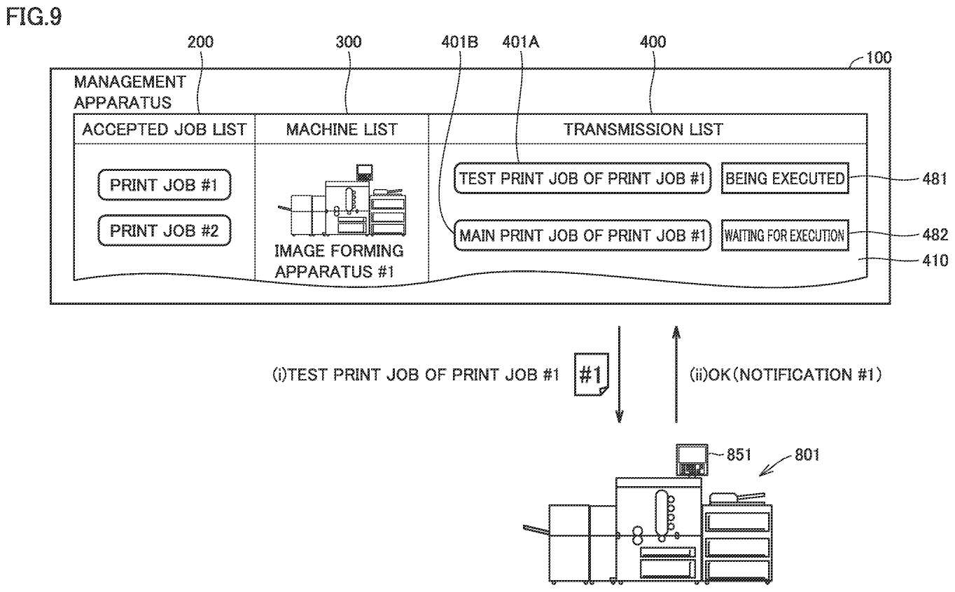

FIG. 9 is a diagram for illustrating transmission and reception of data between management apparatus 100 and image forming apparatus 801 (#1).

Referring to FIG. 9, management apparatus 100 (specifically, communication unit 150) transmits a test print job of print job #1 to designated image forming apparatus 801. When image forming apparatus S01 receives the test print job of prim job #1, it executes the test print job.

Machine manager 891 of image forming apparatus 801 checks a printed product from the test print job of print job #1. When a result of output of test printing presents no problem, machine manager 891 performs a prescribed operation (first operation) onto an operation apparatus 851 of image forming apparatus 801. In this case, image forming apparatus 801 transmits a prescribed notification #1 indicating “OK” to management apparatus 100.

Machine manager 891 may transmit notification #1 to management apparatus 100 by operating an apparatus (for example, a terminal such as a tablet terminal) different from image forming apparatus 801.

FIG. 10 is a diagram for illustrating processing performed after reception by management apparatus 100 of notification #1 from image forming apparatus 801.

Referring to FIG. 10, when management apparatus 100 (specifically, representation controller 115) receives notification #1 from image forming apparatus 801, it varies a character string included in image 481 showing the condition of execution from “being executed” to “done.”

When management apparatus 100 receives notification #1 from image forming apparatus 801, it transmits the main print job of print job #1 to designated image forming apparatus 801. When image forming apparatus 801 receives the main print job of print job #1, it executes the main print job.

When management apparatus 100 transmits the main print job to image forming apparatus 801, it varies a character string included in image 482 showing the condition of execution from “waiting for execution” to “being executed.”

As set forth above, communication unit 150 transmits the main print job of print job #1 to image forming apparatus 801 based on reception of notification #1 based on the prescribed operation (first operation) from image forming apparatus 801. The prescribed operation is an operation performed when a result of output of test printing presents no problem.

Thus, in image forming system 1, as being triggered by reception of notification #1 by management apparatus 100, the main print job is automatically transmitted to image forming apparatus 801. Therefore, job manager 199 does not have to perform an operation to transmit the main print job after it allocates print job #1 to image forming apparatus 801. Therefore, in image forming system 1, lowering in efficiency in works due to forgotten transmission of the main print job by job manager 199 does not occur.

When communication unit 150 receives notification #1 from image forming apparatus 801 as above, representation controller 115 my have image 471 removed. In other words, representation controller 115 may delete images 401A and 481 associated with the test print job of print job #1.

(c6. Case Where Result of Test Printing Presents Problem)

(1) First Case

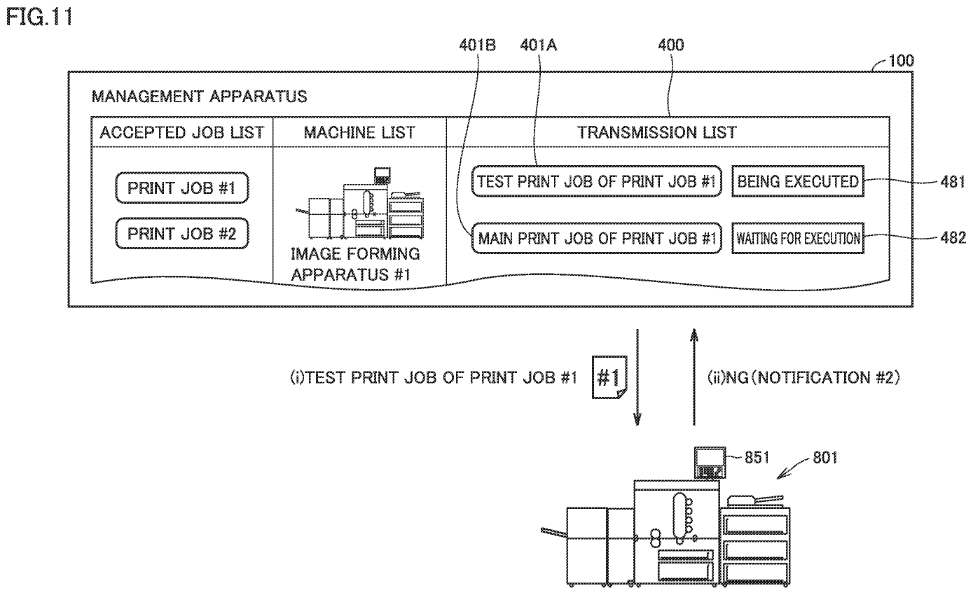

FIG. 11 is a diagram for illustrating transmission and reception of data between management apparatus 100 and image forming apparatus 801 (#1).

Referring to FIG. 11, management apparatus 100 (specifically, communication unit 150) transmits a test print job of print job #1 to designated image forming apparatus 801. When image forming apparatus 801 receives the test print job of print job #1, it executes the test print job.

Machine manager 891 of image forming apparatus 801 checks a printed product from the test print job of print job #1. When a result of output of test printing presents a problem and when a degree of seriousness of the problem is lower than a reference, machine manager 891 performs a prescribed operation (second operation) onto operation apparatus 851 of image forming apparatus 801. In this case, image forming apparatus 801 transmits a prescribed notification #2 indicating “NG” to management apparatus 100. The “degree of seriousness of the problem being lower than the reference” refers, for example, to a case of output of an accidental stain on paper, which results in unwillingness to register that image as the reference image for automatic inspection. Without an accidental problem, printing is likely to be performed without any problem.

Machine manager 891 may transmit notification #2 to management apparatus 100 by operating an apparatus (for example, a terminal such as a tablet terminal) different from image forming apparatus 801.

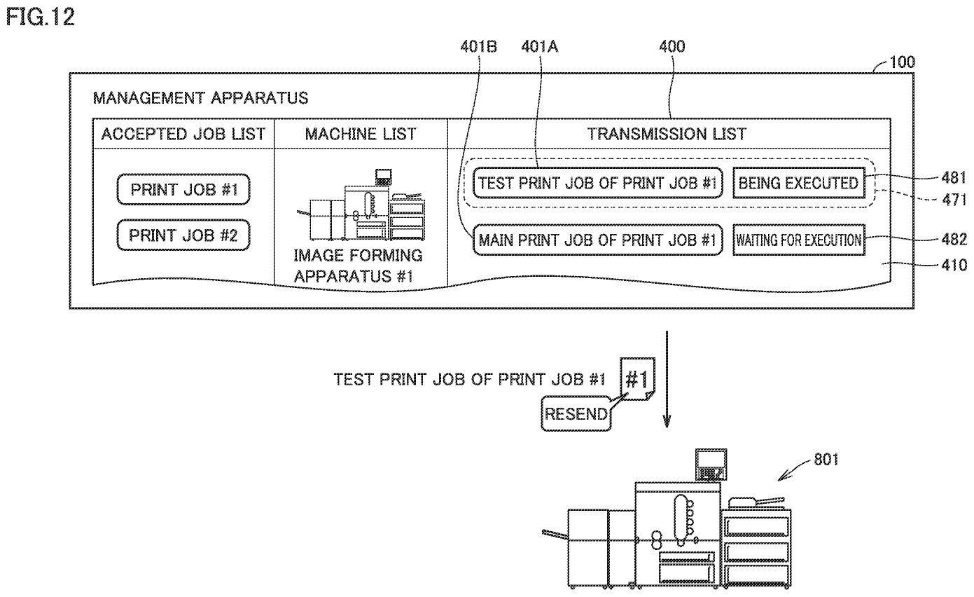

FIG. 12 is a diagram for illustrating processing performed after reception by management apparatus 100 of notification #2 from image forming apparatus 801.

Referring to FIG. 12, when management apparatus 100 (specifically, representation controller 115) receives notification #2 from image forming apparatus 801, it transmits again the test print job of print job #1 to designated image forming apparatus 801. When image forming apparatus 801 receives again the test print job of print job #1, it executes the test print job.

As set forth above, when communication unit 150 receives notification #2 based on the prescribed operation (second operation) from image forming apparatus 801, it sends again the test print job of print job #1 to designated image forming apparatus 801. When communication unit 150 receives notification #2 from image forming apparatus 801, representation controller 115 continues representation of image 471 without erasing (deleting) image 471. Representation controller 115 does not remove image 471.

Thus, when management apparatus 100 receives notification #2 from image forming apparatus 801, it automatically transmits again the test print job to image forming apparatus 801. Therefore, job manager 199 does not have to perform an operation to transmit the test print job again. Therefore, in image forming system 1, lowering in efficiency in works due to forgotten transmission again of the test print job by job manager 199 does not occur.

(2) Second Case

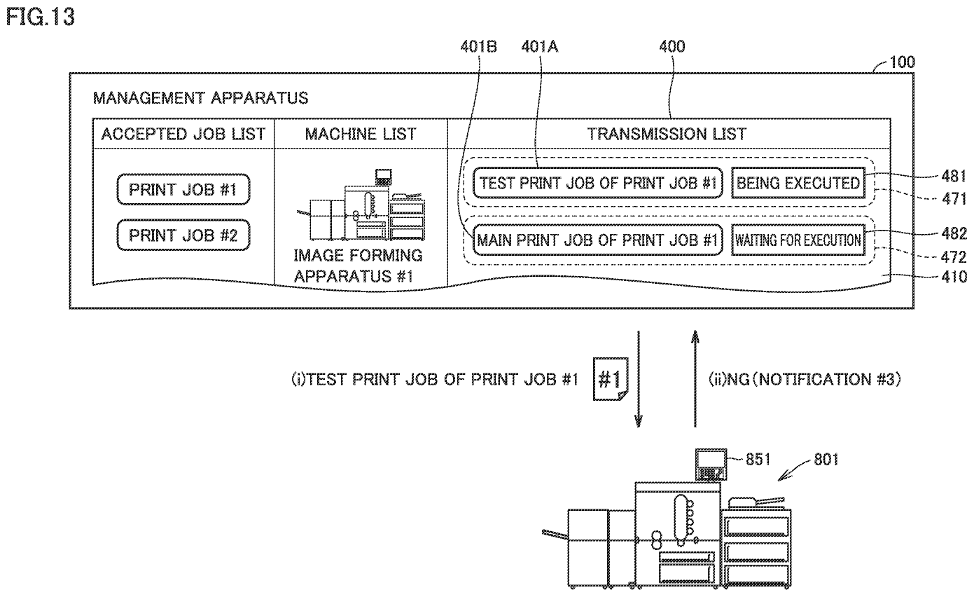

FIG. 13 is a diagram for illustrating transmission and reception of data between management apparatus 100 and image forming apparatus 801 (#1).

Referring to FIG. 13, management apparatus 100 (specifically, communication unit 150) transmits the test print job of print job #1 to designated image forming apparatus 801. When image forming apparatus 801 receives the test print job of print job #1, it executes the test print job.

Machine manager 891 of image forming apparatus 801 checks a printed product from the test print job of print job #1. When a result of output of test printing presents a problem and when the degree of seriousness of the problem is higher than the reference, machine manager 891 performs a prescribed operation (third operation) onto operation apparatus 851 of image forming apparatus 801. In this case, image forming apparatus 801 transmits a prescribed notification #3 indicating “NG” to management apparatus 100. The “degree of seriousness of the problem being higher than the reference” refers, for example, to a case where satisfactory printing cannot be performed even when reprinting is performed, due to a long-term unfavorable condition (error) of image forming apparatus 800. In other words, the “degree of seriousness of the problem being higher than the reference” means that recovery is unlikely.

Machine manager 891 may transmit notification #3 to management apparatus 100 by operating an apparatus (for example, a terminal such as a tablet terminal) different from image forming apparatus 801.

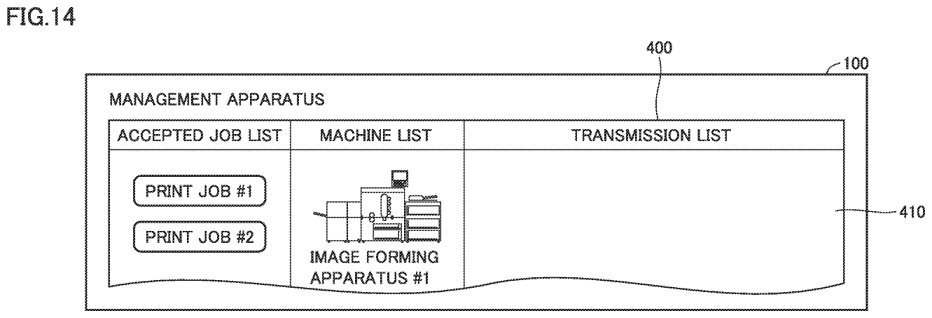

FIG. 14 is a diagram for illustrating processing performed after reception by management apparatus 100 of notification #3 from image forming apparatus 801.

Referring to FIG. 14, mien management apparatus 100 (specifically, representation controller 115) receives notification #3 from image forming apparatus 801, it erases (deletes) image 471 showing the condition of execution of the test print job of print job ill and image 472 showing the condition of execution of the main print job. In other words, representation controller 115 has images 471 and 472 removed.

As set forth above, when communication unit 150 receives notification #3 based on the prescribed operation (third operation) from image forming apparatus 801, management apparatus 100 cancels print job #1 for designated image forming apparatus 801. When communication unit 150 receives notification #3, representation controller 115 erases image 471 and image 472.

According to such a configuration, management apparatus 100 automatically cancels allocation of print job 41 to image forming apparatus 801 based on reception of notification #3. Therefore, a manual operation for canceling allocation by job manager 199 is not required.

(c7. Interrupt Processing)

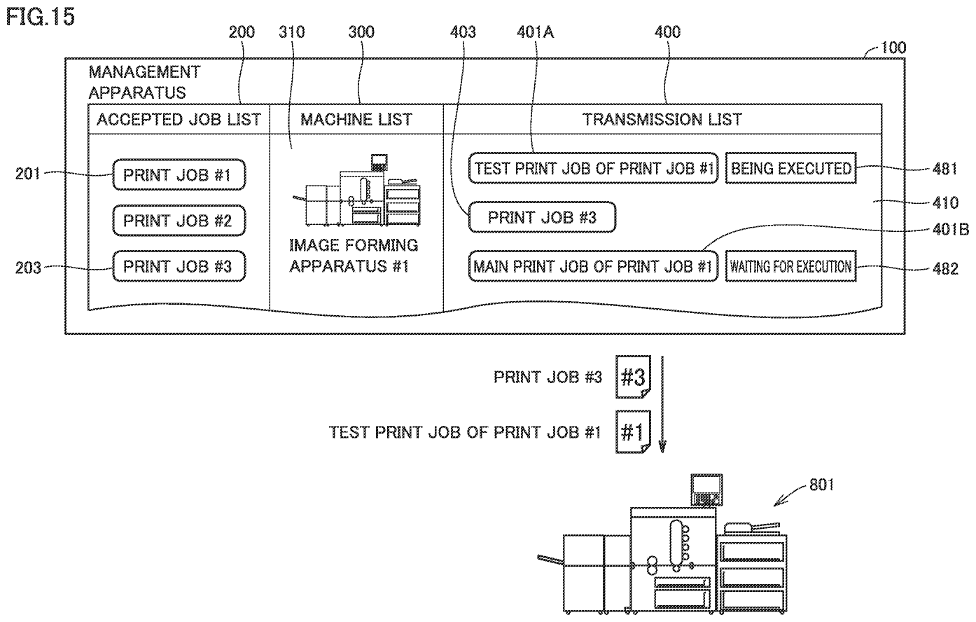

FIG. 15 is a diagram for illustrating processing performed when a print job #3 for which setting of the automatic inspection process has not been made is allocated to image forming apparatus 801.

Referring to FIG. 15, when new print job #3 is allocated to image forming apparatus 801 after print job #1 is allocated to image forming apparatus 801, processing below is performed on condition that notifications #1 to #3 described above have not been received from image forming apparatus 801.

Management apparatus 100 shows an image 403 showing print job #3 within area 410 in transmission list 400. Management apparatus 100 shows image 403 showing print job #3 between image 401A showing the test print job of print job #1 and image 401B showing the main print job of print job #1.

As seen in this representation, print job #3 is prioritized over the main print job of print job #1. In other words, after management apparatus 100 transmits the test point job of print job #1 to image forming apparatus 801, it transmits prim job #3 to image forming apparatus 801 before the main print job of print job #1. Image forming apparatus 801 thus executes print job #3 before the main print job of print job #1.

As set forth above, when setting for performing printing as being divided into test printing and main printing has not been made for print job #3 and when print job #3 is executed in image forming apparatus 801, print job #3 is transmitted to image for apparatus 801 before the main print job of print job #1 on condition that notifications #1 to #3 have not been received.

Unless management apparatus 100 receives notification #1 that a result of test printing indicates OK, the main print job of print job #1 is not transmitted to image forming apparatus 801. It takes some time to check test printing. Therefore, by transmitting print job #3 that does not have to be subjected to test printing to image forming apparatus 801 before the main print job of print job #1, print job #3 is promptly executed.

Therefore, according to the configuration, an availability factor of image forming apparatus 801 can be higher than in the configuration where print job #3 is transmitted to image forming apparatus 801 after main printing of print job #1.

<D. Control Structure>

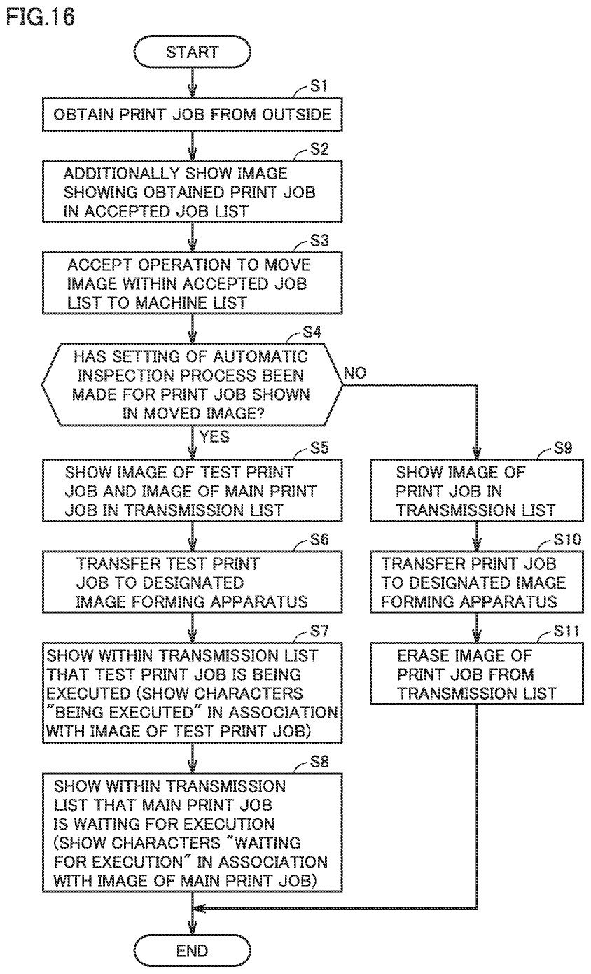

FIG. 16 is a flowchart for illustrating an exemplary flow of processing performed in management apparatus 100.

Referring to FIG. 16, in step S1, job obtaining unit 120 of management apparatus 100 obtains a print job from the outside. In step S2, controller 110 of management apparatus 100 has an image showing the obtained print job additionally shown in accepted job list 200.

In step S3, operation acceptance unit 130 accepts an operation to move the image within accepted job list 200 to machine list 300 (the operation by job manager 199). In step S4, controller 110 determines whether or not setting of the automatic inspection process has been made for the print job shown in the image moved to machine list 300. Controller 110 determines whether or not setting of the automatic inspection process has been made for the print job, for example, based on a flag for the automatic inspection process.

When it is determined that setting of the automatic inspection process has been made for the print job (YES in step S4), in step S5, representation controller 115 has an image (for example, image 401A in FIG. 7) showing the test print job and an image (for example, image 401E in FIG. 7) showing the main print job shown within the transmission list. Specifically, representation controller 115 has both of these images shown within an area (for example, area 410 in FIG. 7) corresponding to designated image forming apparatus 800. In step S6, communication unit 150 transmits the test print job to image forming apparatus 800 designated by job manager 199.

In step S7, representation controller 115 has an image (for example, image 481 in FIG. 7) including the character string “being executed” shown in correspondence with the image showing the test print job. In step S8, representation controller 115 has an image (for example, image 481 in FIG. 7) including the character string “waiting for execution” shown in correspondence with the image showing the main print job.

The order of processing in step S5 to step S8 is by way of example, and the order is not limited thereto.

When it is determined that setting of the automatic inspection process has not been made for the print job (NO in step S4), in step S9, representation controller 115 has an image showing the print job shown in transmission list 400. In step S110, communication unit 150 transmits the print job to designated image forming apparatus 800. In step S11, representation controller 115 erases (deletes) the image showing the print job from transmission list 400.

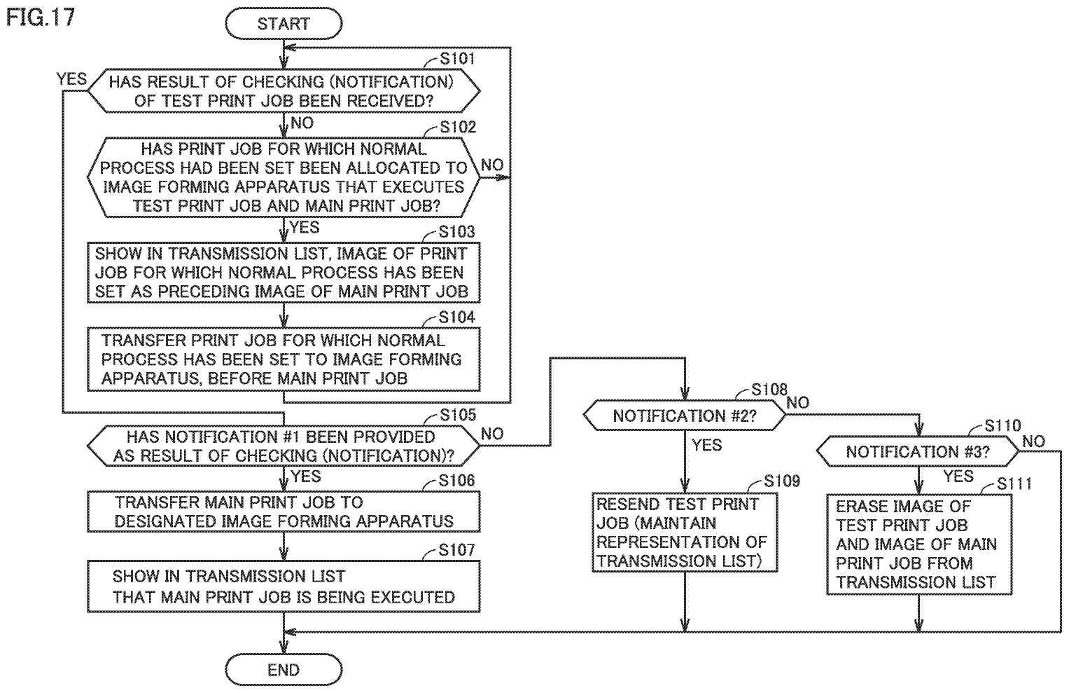

FIG. 17 is a diagram for illustrating an exemplary flow of processing performed in management apparatus 100 after transmission of the test print job to image forming apparatus 800.

Referring to FIG. 17, in step S101, controller 110 determines whether or not it has received a result of checking (notification) of the test print job. When controller 110 determines that it has received the result of checking (YES in step S101), the process proceeds to step S105.

When controller 110 determines that it has not received the result of checking (NO in step S101), it determines whether or not the print job for which the normal process had been set has been allocated to image forming apparatus 800 to execute the test print job and the main print job.

When controller 110 determines that the print job has not been allocated (NO in step S102), the process proceeds to step S101.

When controller 110 determines that the print job has been allocated (YES in step S102), in step S103, it has an image showing the print job for which the normal process has been set shown above the image showing the main print job (see FIG. 15). In step S104, communication unit 150 transmits the print job for which the normal process has been set to image forming apparatus 800 before the main print job (see FIG. 15). Thereafter, the process proceeds to step S101.

In step S105, controller 110 determines whether or not it has received notification #1 described above as the result of checking. Notification #1 is a notification transmitted from image forming apparatus 800 or the like to management apparatus 100 when the result of checking presents no problem.

When it is determined that notification #1 has been received (YES in step S105), in step S106, communication unit 150 transmits the main print job to designated image forming apparatus 800. In step S107, representation controller 115 has an indication that the main print job is being executed shown in transmission list 400 (see FIG. 10).

When controller 110 determines that it has not received notification #1 (NO in step S105), in step S108, it determines whether or not it has received notification #2 described above as the result of checking.

When it is determined that notification #2 has been received (YES in step S108), in step S109, communication unit 150 transmits again the test print job to designated image forming apparatus 800. The image showing the test print job is shown in transmission list 400 without being erased (see FIG. 12). When controller 110 determines that it has not received notification #2 (NO in step S108), in step S110, it determines whether or not it has received notification #3 described above as the result of checking.

When it is determined that notification #3 has been received (YES in step S110), in step S111, communication unit 150 erases the image showing the test print job and the image showing the main print job from the transmission list. When controller 110 determines that it has not received notification #3 (NO in step S110), it quits a series of processing.

<E. Modification>

(e1. First Modification)

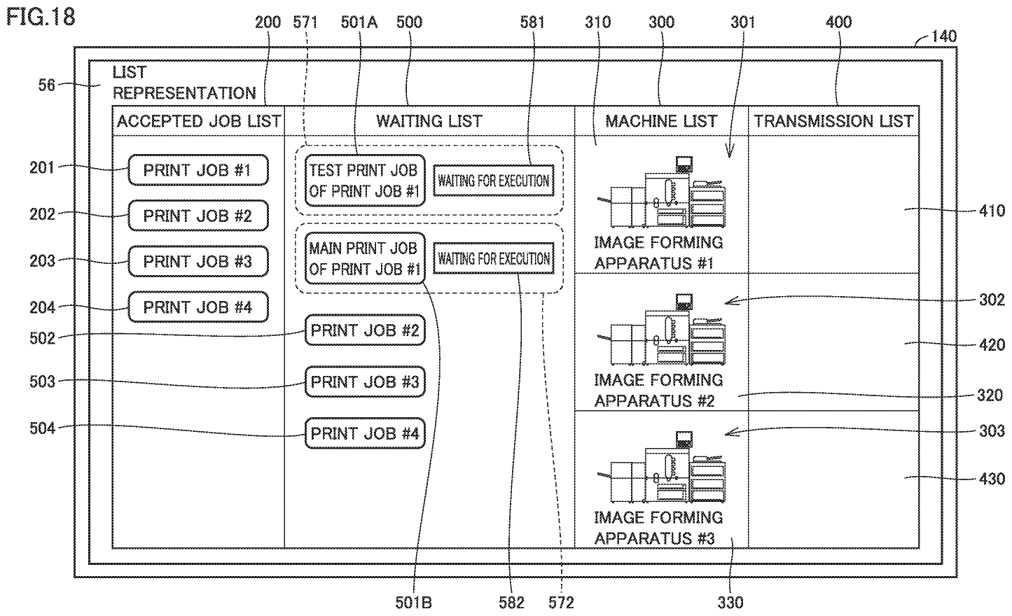

A modification of a screen shown in management apparatus 100 will be described with reference to FIGS. 18 to 20.

FIG. 18 is a diagram showing a screen shown on display 140.

Referring to FIG. 18, management apparatus 100 (specifically, representation controller 115) shows a plurality of lists on display 140. Management apparatus 100 shows accepted job list 200, a waiting list 500, machine list 300, and transmission list 400 as being aligned. Management apparatus 100 shows waiting list 500 between accepted job list 200 and machine list 300.

When job obtaining unit 120 obtains a print job, management apparatus 100 shows an image showing the obtained job within accepted job list 200. In the present example, four images 201 to 204 showing four print jobs #1 to #4, respectively, are shown in accepted job list 200.

Job manager 199 sets whether to perform the normal process or the automatic inspection process for each of print jobs #1 to #4 within the accepted job list, by using the checkbox described above (see FIG. 5). In the present example, it is assumed that setting of the automatic inspection process is made only for print job #1 among print jobs #1 to #4.

Job manager 199 moves images 201 to 204 showing print jobs #1 to #4 into waiting list 500 by using the mouse or the like. At this time point, print jobs #1 to #4 have not yet been allocated to image forming apparatus 800.

Setting of the automatic inspection process has been made for print job 41 as described above. Therefore, when operation acceptance unit 130 accepts an operation to move image 201 showing print job #1 from accepted job list 200 to waiting list 500, representation controller 115 has display 140 show in waiting list 500, an image 571 showing the condition of execution of the test print job of print job 41 and an image 572 showing the condition of execution of the main print job.

Specifically, image 571 includes an image 501A showing the test print job and an image 581 showing the condition of execution. Image 572 includes an image 501B showing the main print job and an image 582 showing the condition of execution. An indication (a character string) of the condition of execution included in image 581 and image 582 is varied successively in accordance with the condition of execution.

When operation acceptance unit 130 accepts an operation to move images 202 to 204 showing print jobs #2 to #4 from accepted job list 200 to waiting list 500, representation controller 115 has an image 502 showing print job #2, an image 503 showing print job #3, and an image 504 showing a print job #4 shown in waiting list 500.

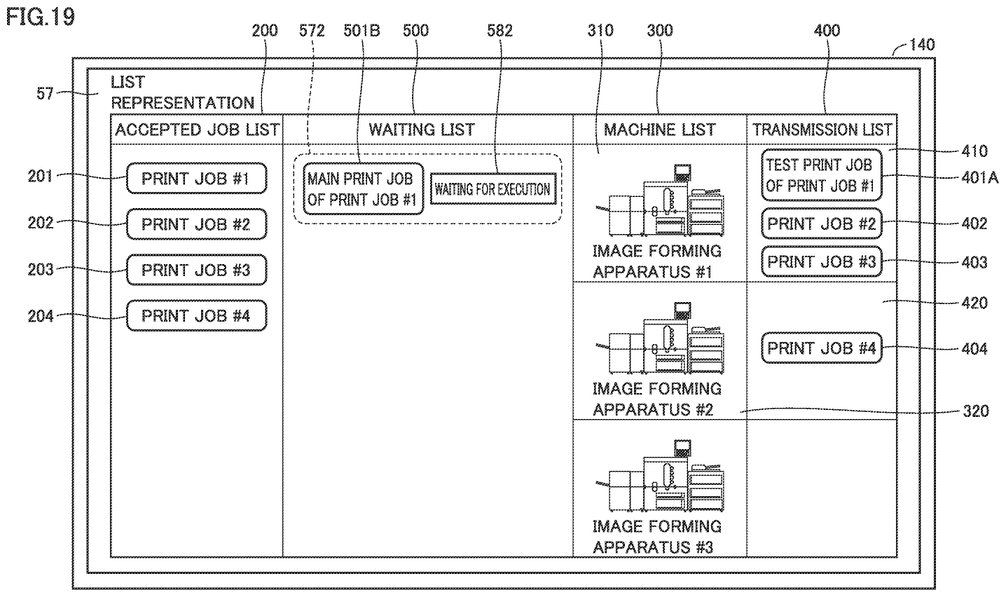

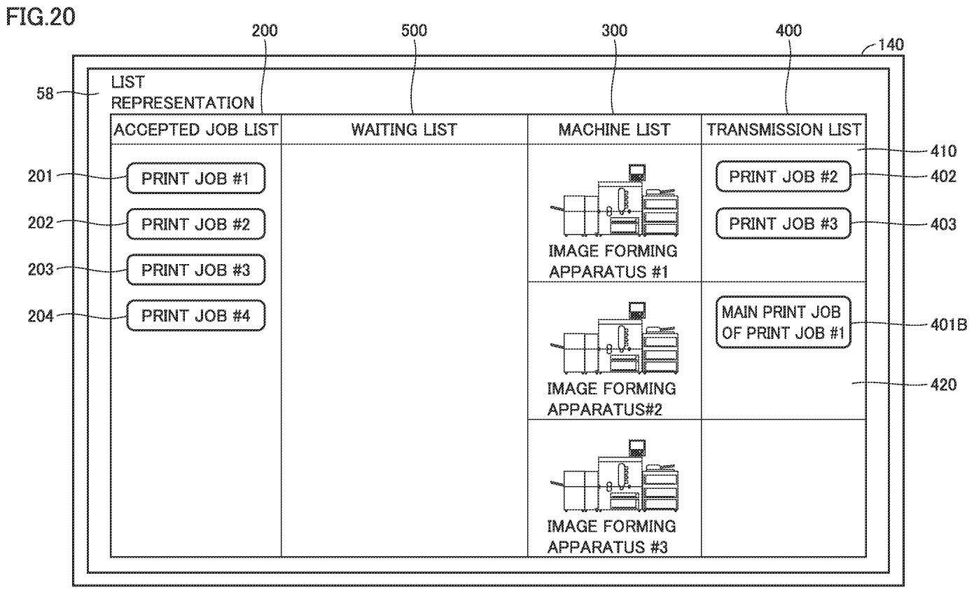

FIGS. 19 and 20 are each a diagram for illustrating processing performed when a print job is allocated to image forming apparatus 800. FIG. 19 shows a screen after transition from FIG. 18. FIG. 20 shows a screen after transition from FIG. 19.

Referring to FIGS. 18 and 19, job manager 199 moves image 501A showing the test print job of print job 41 within waiting list 500 into area 301 in machine list 300 by using the mouse or the like. By performing such an operation, the test print job of print job #1 is allocated to image forming apparatus #1 (801). Furthermore, representation controller 115 has image 401A showing the test print job of print job #1 shown within area 410 in transmission list 400.

In succession, job manager 199 moves image 502 showing print job #2 within waiting list 500 into area 301 in machine list 300 by using the mouse or the like. By performing such an operation, print job #2 is allocated to image forming apparatus #1 (801). Furthermore, representation controller 115 has image 402 showing print job #2 shown within area 410 in transmission list 400. Thereafter, job manager 199 performs an operation to allocate print job #3 to image forming apparatus #1 similarly to print job #2.

Furthermore, job manager 199 performs an operation to allocate print job #4 to image forming apparatus #2 (802). In other words, job manager 199 moves an image 504 showing print job 44 within waiting list 500 into area 302 in machine list 300 by using the mouse or the like.

Representation controller 115 erases the image showing the allocated print job from waiting list 500 based on allocation of the print job to image forming apparatus 800.

Through the operations and processing above, the screen shown in FIG. 19 is shown on display 140.

Referring to FIGS. 19 and 20, job manager 199 moves image 501B showing the main print job of print job #1 within waiting list 500 into area 302 in machine list 300 by using the mouse or the like. By performing such an operation, the main print job of print job #1 is allocated to image forming apparatus #2 (802) different from the apparatus for the test print job. Furthermore, representation controller 115 has image 401B showing the main print job of print job #1 shown within area 420 in transmission list 400. In the present example, management apparatus 100 erases image 401A showing the test print job of print job #1 from area 410 in transmission list 400, because it has received notification #1 indicating “OK” as the result of checking of that test print job.

Through the operations and processing above, the screen shown in FIG. 20 is shown on display 140.

According to the configuration including such waiting list 500, the test print job and the main print job can be executed by different image forming apparatuses 800. Therefore, job manager 199 can select image forming apparatus 800 to which the main print job is to be allocated, in view of toads imposed on each image forming apparatus 800. Therefore, efficiency of image forming system 1 as a whole can be enhanced.

(e2. Second Modification)

(1) When reprinting based on a test print job or a main print job is being performed, representation controller 115 may add prescribed representation to representation indicating “being executed” in transmission list 400. For example, representation controller 115 may have “being executed (NG: reprint)” shown in image 481, 482, or the like.

(2) When the test print job or the main print job ends in midway without being completed, representation controller 115 may add prescribed representation to representation indicating “done”. For example, representation controller 115 may have “being executed (NG: stop)” shown in image 481, 482, or the like.

<F. Additional Aspects>

A print job management apparatus includes obtaining means for obtaining a first print job and representation control means for controlling a display to show, when setting for performing printing as being divided into test printing and main printing has been made for the first print job, a first image showing a condition of execution of a job of the test printing and a second image showing a condition of execution of a job of the main printing.

Preferably, the representation control means controls the display to show based on designation of an image forming apparatus to execute the first print job, the first image and the second image in association with a third image showing the designated image forming apparatus.

Preferably, the print job management apparatus can communicate with a plurality of image forming apparatuses. The print job management apparatus further includes acceptance means for accepting an operation to designate the image forming apparatus to execute the first print job among the plurality of image forming apparatuses. The representation control means controls the display to show the first image and the second image in association with the third image based on acceptance of the operation by the acceptance means.

Preferably, when the first print job is obtained, the representation control means controls the display to show a fourth image showing the first print job as a single job. The representation control means controls the display to show the first image and the second image based on designation of an image forming apparatus to execute the first print job after the fourth image is shown.

Preferably, the condition of execution of the job of the test printing and the condition of execution of the job of the main printing are any of “waiting for execution,” “being executed,” and “done”.

Preferably, when reprinting based on the job of the test printing or the job of the main printing is being performed, the representation control means adds prescribed representation to representation indicating “being executed.”

Preferably, when the job of the test printing or the job of the main printing ends in midway without being completed, the representation control means adds prescribed representation to representation indicating, “done”.

Preferably, the representation control means controls the display to show the first image as preceding the second image.

Preferably, the print job management apparatus further includes communication means for communicating with the designated image forming apparatus. The communication mans transmits the job of the main printing to the designated image forming apparatus based on reception of a first notification based on a first operation from a prescribed device.

Preferably, the first operation is an operation performed when a result of output of test printing presents no problem.

Preferably, the obtaining means further obtains a second print job. When setting for performing printing as being divided into test printing and main printing has not been made for the second print job and when the second print job is executed in the designated image forming apparatus, the communication means transmits the second print job to the designated image forming apparatus before the job of the main priming on condition that it has not received the first notification.

Preferably, when the communication means receives the first notification, c representation control means erases the first image.

Preferably, when the communication means receives a second notification based on a second operation from the prescribed device, it sends again the job of the test printing to the designated image forming apparatus.

Preferably, when the communication means receives the second notification based on the second operation from the prescribed device, the representation control means continues representation of the first image.

Preferably, the second operation is an operation performed when a result of output of test printing presents a problem and when a degree of seriousness of the problem is lower than a reference.

Preferably, when the communication means receives a third notification based on a third operation from the prescribed device, the print job management apparatus cancels the first print job for the designated image forming apparatus.

Preferably, when the communication means receives the third notification, the representation control means erases the first image and the second image.

Preferably, the third operation is an operation performed when the result of output of test printing presents a problem and when a degree of seriousness of the problem is higher than a reference.

Preferably, the prescribed device is the designated image forming apparatus.

Although embodiments of the present invention have been described and illustrated in detail, the disclosed embodiments are made for the purposes of illustration and example only and not limitation. The scope of the present invention should be interpreted by terms of the appended claims.

What is claimed is:

1. A print job management apparatus comprising:
a processor; and
a memory that stores an obtained first print job, wherein
when setting for performing printing as being divided into test printing and main printing has been made for the first print job, the processor has a display show a first image showing a condition of execution of a job of the test printing and a second image showing a condition of execution of a job of the main printing.

2. The print job management apparatus according to claim 1, wherein
the processor has the display show, based on designation of an image forming apparatus to execute the first print job, the first image and the second image in association with a third image showing the designated image forming apparatus.

3. The print job management apparatus according to claim 2, being capable of communicating with a plurality of image, forming apparatuses, wherein
the processor accepts an operation instruction to designate the image forming apparatus to execute the first print job among the plurality of image, forming apparatuses, and has the display show the first image and the second image in association with the third image based on acceptance of the operation instruction.

4. The print job management apparatus according to claim 1, wherein
when the processor obtains the first print job, the processor has the display show a fourth image that shows the first print job as a single job, and
the processor has the display show the first image and the second image based on designation of an image forming apparatus that executes the first print job after the fourth image is shown.

5. The print job management apparatus according to claim 1, wherein
the condition of execution of the job of the test printing and the condition of execution of the job of the main printing are any one of “waiting for execution,” “being executed,” and “done”.

6. The print job management apparatus according to claim 5, wherein
when reprinting based on the job of the test printing or the job of the main printing is being executed, the processor adds prescribed representation to representation indicating “being executed.”

7. The print job management apparatus according to claim 5, wherein
when the job of the test printing or the job of the main printing ends in midway without being completed, the processor adds prescribed representation to representation indicating “done”.

8. The print job management apparatus according to claim 1, wherein
the processor has the display show the first image as preceding the second image.

9. The print job management apparatus according to claim 2, further comprising a communication apparatus that communicates with the designated image forming apparatus, wherein
the communication apparatus transmits the job of the main printing to the designated image forming apparatus based on reception of a first notification based on a first operation from a prescribed device.

10. The print job management apparatus according to claim 9, wherein
the first operation is an operation performed when a result of output of the test printing presents no problem.

11. The print job management apparatus according to claim 9, wherein
the processor further obtains a second print job, and
when setting for performing printing as being divided into test printing and main printing has not been made for the second print job and when the second print job is executed in the designated image forming apparatus, the communication apparatus transmits the second print job to the designated image forming apparatus before the job of the main printing on condition that the communication apparatus has not received the first notification.

12. The print job management apparatus according to claim 9, wherein
when the communication apparatus receives the first notification, the processor erases the first image.

13. The print job management apparatus according to claim 9, wherein
when the communication apparatus receives a second notification based on a second operation from the prescribed device, the communication apparatus resends the job of the test printing to the designated image forming apparatus.

14. The print job management apparatus according to claim 13, wherein
when the communication apparatus receives the second notification based on the second operation from the prescribed device, the processor continues representation of the first image.

15. The print job management apparatus according to claim 14, wherein
the second operation is an operation performed when a result of output of the test printing presents a problem and when a degree of seriousness of the problem is lower than a reference.

16. The print job management apparatus according to claim 13, wherein
when the communication apparatus receives a third notification based on a third operation from the prescribed device, the print job management apparatus cancels the first print job for the designated image forming apparatus.

17. The print job management apparatus according to claim 16, wherein
when the communication apparatus receives the third notification, the processor erases the first image and the second image.

18. The print job management apparatus according to claim 16, wherein
the third operation is an operation performed when a result of output of the test printing presents a problem and when a degree of seriousness of the problem is higher than a reference.

19. The print job management apparatus according to claim 9, wherein
the prescribed device is the designated image forming apparatus.

20. An image forming system comprising:
a print job management apparatus and
an image forming apparatus, wherein
the print job management apparatus
obtains a print job from outside,
has the image forming apparatus execute the obtained print job, and
shows, when setting for performing printing as being divided into test printing and main printing has been made for the print job, a first image showing a condition of execution of a job of the test printing and a second image showing a condition of execution of a job of the main printing.

21. A representation control method comprising:
obtaining a print job; and
showing, when setting for performing printing as being divided into test printing and main printing has been made for the print job, a first image showing a condition of execution of a job of the test printing and a second image showing a condition of execution of a job of the main printing.
